(19) United States
(12) Patent Application Publication
(10) Pub. No.: US 2024/0250760 A1
(43) Pub. Date: Jul. 25, 2024

(54) MIMO PANEL GAIN CALIBRATION

(71) Applicant: Rakuten Symphony UK Ltd, Surrey (GB)

(72) Inventors: Hugh Roger McCalman, Surrey (GB); Stephen Hedges, Surrey (GB)

(73) Assignee: Rakuten Symphony UK Ltd, Surrey (GB)

(21) Appl. No.: 18/018,251

(22) PCT Filed: Jul. 29, 2022
(86) PCT No.: PCT/US22/38771

§ 371 Date: Jan. 26, 2023

(51) Int. Cl. H04B 17/14; H04B 7/0413; H04B 17/21

(52) U.S. Cl. CPC H04B 17/14; H04B 7/0413; H04B 17/22

(57) ABSTRACT

In some implementations, a MIMO calibrating apparatus may include coupling a plurality of input/output paths of a MIMO antenna panel to a plurality of transmit or receive paths of a MIMO radio panel, and measuring a loss of each of the plurality of input/output paths of the MIMO antenna panel at an input for a common calibration receiver port of the MIMO radio panel. The apparatus may include coupling a calibration feedback network of the MIMO antenna panel to the common calibration receiver port of the MIMO radio panel. The apparatus may include transmitting or receiving at a known power level by the MIMO radio panel, measuring a power output of all transmit or receive paths, and calibrating a transmit gain or a receive loss according to the measured loss at each input/output path of the MIMO antenna panel at the input for the common calibration receiver port.

### TECHNICAL FIELD

In some example embodiments, the subject matter herein generally relates to calibration of transceiver paths.

### BACKGROUND

Wireless equipment manufactures typically perform calibration of a radio panel coupled to an antenna configuration to determine the transceiver gain or loss between the ratio transceiver and antenna. This calibration is necessary so that when the radio panel/antenna assembly is complete the gain/loss of the transceiver/antenna assembly is known. When the transceiver/antenna assembly is incorporated into a wireless system, the wireless system designer(s) can account for the transceiver/antenna assembly gain/loss.

This process of coupling the ratio transceiver and antenna is often performed in a test area or testing station. The test area of may be located in close proximity to the area where the wireless equipment is manufactured or in an off-site location where various components, such as the radio panel and antenna, are assembled. When the radio panel in coupled to the antenna in a manufacturing environment or assembly station, the calibration is performed.

During the process of coupling the radio panels with the antennas in a manufacturing and/or testing environment, a switch box is typically used to perform the calibration of multiple transceiver/antenna assemblies.

The switch box allows test personnel to perform calibration of multiple transceiver/antenna assemblies without having to individually configure each test setup. A switch box appears to be a reasonable solution where the radio panel and antenna only require a single connection.

In a Multiple-Input-Multiple-Output (MIMO) implementation a radio panel is comprised of multiple radio panels and corresponding transmit/receive paths, and an antenna panel is comprised of multiple transmit/receive paths to be coupled with the transmit/receive paths of the radio panel.

In a manufacturing environment, calibration for each transmit/receive path is necessary after coupling the radio panel and antenna panel. This calibration is needed so that when the MIMO transceiver/antenna assembly is complete the gain/loss of the assembly is known. When the MIMO transceiver/antenna assembly is incorporated into a wireless system, the wireless system designer(s) can account for the MIMO transceiver/antenna assembly gain/loss.

However, in a MIMO application where a radio panel has multiple transceivers and an antenna panel has multiple transmit/receive paths each transmit/receive path needs to be calibrated. The use of a of a switch box to calibrate the multiple transceiver paths coupled to the multiple transmit/receive paths of the antenna panel makes the switch box more complicated. In addition, the use and maintenance of the switch is time consuming and subject to errors.

Thus, the need exists for an efficient method and apparatus for calibrating the receive gain/loss of the transmit/receive paths of a MIMO radio panel coupled with a MIMO antenna panel.

### SUMMARY

In one aspect, a method of calibrating MIMO transceiver paths in a test environment is provided. The method may include coupling a plurality of input/output paths of a MIMO antenna panel to a plurality of transmit or receive paths of a MIMO radio panel. The method may include measuring a loss of each of the plurality of input/output paths of the MIMO antenna panel at an input for a common calibration receiver port of the MIMO radio panel. The method may further include coupling a calibration feedback network of the MIMO antenna panel to the common calibration receiver port of the MIMO radio panel. The method may in addition include transmitting or receiving at a known power level by the MIMO radio panel. The method may moreover include measuring a power output of all transmit or receive paths. The method may also include calibrating a transmit gain or a receive loss according to the measured loss at each input/output path of the MIMO antenna panel at the input for the common calibration receiver port. Other embodiments of this aspect include corresponding computer systems, apparatus, and computer programs recorded on one or more computer storage devices, each configured to perform the actions of the methods.

Implementations may include one or more of the following features. The method where the transmit path corresponds with the MIMO radio panel functioning as a transmitter and the receive path corresponds with the MIMO radio panel functioning as a receiver. The method where measuring the loss of each input/output path of the MIMO antenna panel at the input for the common calibration receiver port is performed during a manufacturing process for the MIMO antenna panel. The method where the calibration feedback network is built into the antenna panel during a manufacturing process for the MIMO antenna panel to perform operational phase alignment on the MIMO antenna panel. The method where measuring the loss of each input or output path of the MIMO antenna panel at the input for the common calibration receiver port is a single power measurement before the MIMO antenna panel is coupled to the MIMO radio panel. The method where once one transmit path is set, the common calibration receiver port can be referenced through the calibration feedback network. The method where a relative loss of each path from the MIMO antenna panel to the input for the common calibration receiver port is known via the calibration feedback network of the MIMO antenna panel. The method where each transmit or receive path includes a digital-to-analog converter (DAC) and an analog-to-digital converter (ADC) pair. Implementations of the described techniques may include hardware, a method or process, or a computer tangible medium.

In another aspect, a MIMO calibrating apparatus is provided. The MIMO calibrating apparatus may include an antenna panel and a MIMO radio panel where each of a plurality input/output paths of the MIMO antenna panel is coupled to each of a plurality of transmit or receive paths of the MIMO radio panel. The MIMO antenna panel including: a calibration feedback network; and measurement data corresponding to a measured loss of each input or output path of the MIMO antenna panel to an input for a common calibration receiver port of the MIMO radio panel, where the calibration feedback network of the MIMO antenna panel is coupled to the common calibration receiver port of the MIMO radio panel. The MIMO radio panel may be configured to: transmit or receive data at a known power level; measure a power output of all transmit or receive paths; and calibrate a transmit gain or a receive loss according to the measurement data which is received at the common calibration receiver port of the MIMO radio panel. Other embodiments of this aspect include corresponding computer systems, apparatus, and computer programs recorded on one or more computer storage devices, each configured to perform the actions of the methods.

Implementations may include one or more of the following features. Method where the transmit path corresponds with the MIMO radio panel functioning as a transmitter and the receive path corresponds with the MIMO radio panel functioning as a receiver. Method where measuring the loss of each input/output path of the MIMO antenna panel at the input for the common calibration receiver port is performed during a manufacturing process for the MIMO antenna panel. Method where the calibration feedback network is built into the antenna panel during a manufacturing process for the MIMO antenna panel to perform operational phase alignment on the MIMO antenna panel. Method where measuring the loss of each input or output path of the MIMO antenna panel at the input for the common calibration receiver port is a single power measurement before the MIMO antenna panel is coupled to the MIMO radio panel. Method where once one transmit path is set the common calibration receiver port can be referenced through the calibration feedback network. Method where a relative loss of each path from the MIMO antenna panel to the input for the common calibration receiver port is known via the calibration feedback network of the MIMO antenna panel. Method where each transmit or receive path includes a digital-to-analog converter (DAC) and an analog-to-digital converter (ADC) pair. Implementations of the described techniques may include hardware, a method or process, or a computer tangible medium.

Additional implementations may include one or more of the following features. The MIMO calibrating apparatus where the transmit path corresponds with the MIMO radio panel functioning as a transmitter and the receive path corresponds with the MIMO radio panel functioning as a receiver. The MIMO calibrating apparatus where the measurement data corresponding to a measured loss of each input or output path of the MIMO antenna panel is generated during a manufacturing process for the MIMO antenna panel. The MIMO calibrating apparatus where the measurement data is derived from a single power measurement before the MIMO antenna panel is coupled to the MIMO radio panel. The MIMO calibrating apparatus where the common calibration feedback network is built into the antenna panel during a manufacturing process for the MIMO antenna panel to perform operational phase alignment on the MIMO antenna panel. The MIMO calibrating apparatus where once one transmit path is set at a known power level the calibration receiver port can be referenced through the calibration feedback network. The MIMO calibrating apparatus where a relative loss of each path from the MIMO antenna panel at the input for the common calibration receiver port is known via the calibration feedback network of the MIMO antenna panel. The MIMO calibrating apparatus where each transmit or receive path includes a digital-to-analog converter (DAC) and an analog-to-digital converter (ADC) pair. Implementations of the described techniques may include hardware, a method or process, or a computer tangible medium.

### BRIEF DESCRIPTION OF THE DRAWINGS

In the following drawings:

FIG. 1 is a diagram of an exemplary MIMO antenna panel;

FIG. 2 is a diagram of an exemplary MIMO radio panel;

FIG. 3 is diagram of an exemplary MIMO radio panel and MIMO antenna panel assembly a;

FIG. 4 is a flowchart representing a process of MIMO gain calibration according to an embodiment; and

FIG. 5 is a flowchart representing a process of MIMO gain calibration according to further embodiments.

### DETAILED DESCRIPTION

MIMO typically supports the use of multiple data streams transmitted and received between a transmitting and receiving device. Thus, when two MIMO capable devices are connected, multiple data streams within the same frequency channel may be transmitted in parallel. Thus, the throughput between the MIMO capable device is effectively increased without using resources of additional frequency bands.

Currently, many handheld MIMO devices use a 4×4 MIMO configuration. That is 4 transmit and receive antennas at each end of the connection. However, 2×2 MIMO configurations are also used, and more recently the use of 8×8 MIMO configurations have been considered. Typically a MIMO antenna panel design is in the form of a printed circuit board (PCB), and the antenna placement, routing, impedance matching and grounding are part of the PCB design. A MIMO antenna is designed according to the desired frequency and bandwidth. In addition the MIMO antennas are typically isolated from each other.

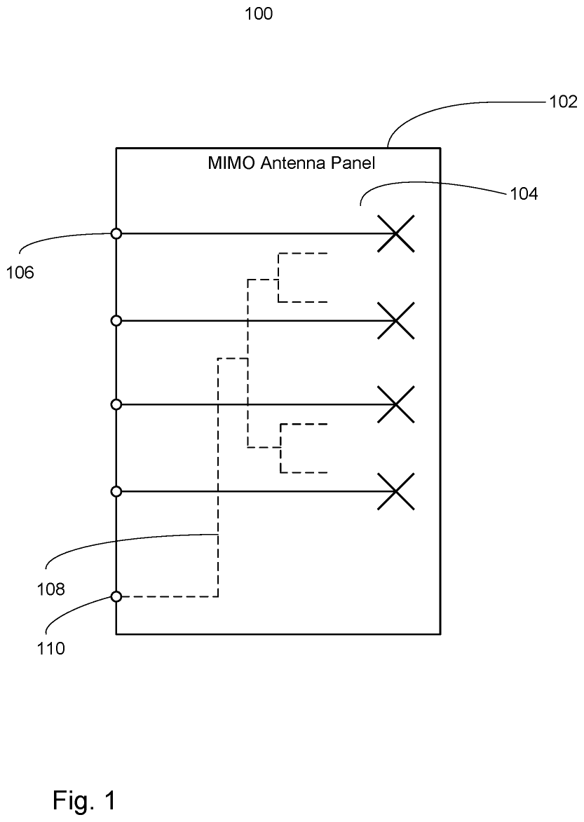

FIG. 1 illustrates an antenna panel according to an embodiment. For ease of reference, the antenna panel 102 may be used to illustrate the transmit path or the receive path. In an embodiment, a MIMO antenna panel 102 includes antenna and transmission line 104, antenna coupling point 106, a calibration feedback network 108, and calibration feedback network coupling point 110. It should be understood that the antenna panel may include multiple antenna and transmission lines 104, and multiple antenna coupling points 106. For example, as shown in FIG. 1, a 4×4 MIMO antenna panel may include four antenna and transmission lines 104, and four antenna coupling points 106.

It should be appreciated that a 4×4 MIMO antenna panel is shown as one example. Other examples may include a 2×2 MIMO antenna panel that may be configured with two antenna and transmission lines 104, and two antenna coupling points 106, a 3×3 MIMO antenna panel may include two antenna and transmission lines 104 and two antenna coupling points 106, and an 8×8 MIMO antenna panel may include eight antenna and transmission lines 104, and eight antenna coupling points 106. Thus, the description is not limited to a 4×4 MIMO antenna panel.

Several methods may be used to provide antenna diversity. The methods include beamforming, polarization coding and spatial multiplexing. Beamforming may follow a phased array layout. Calibration feedback network 108 is typically built into the antenna panel 102 during the manufacturing process. The calibration feedback network may be used during the manufacturing process to facilitate the operational phase alignment.

Antenna coupling points 106 are to be coupled with a corresponding number of radio panel coupling points, and calibration feedback network coupling point 110 is to be coupled with a common calibration receiver port of a MIMO antenna panel. Calibration feedback network 108 connects a coupled portion of each transmit path 104 of antenna panel 102.

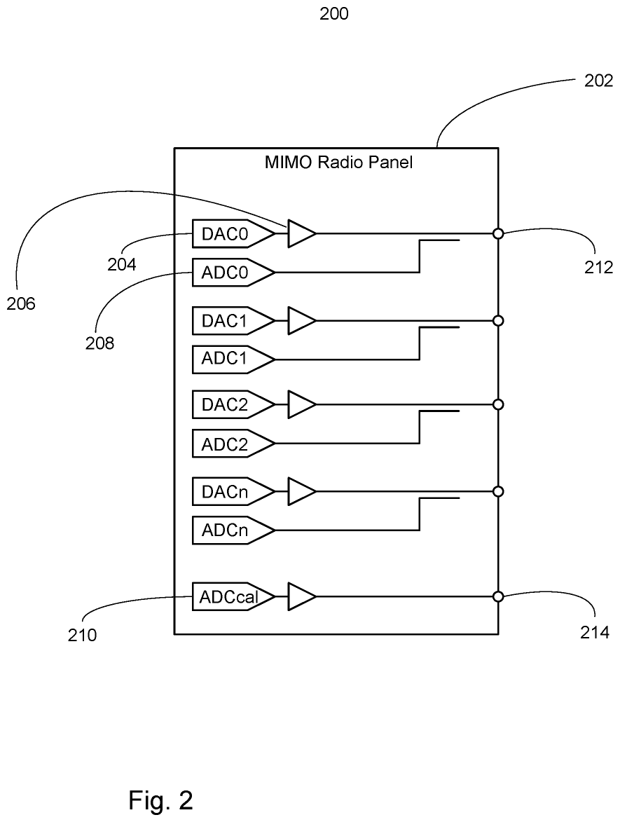

FIG. 2 illustrates a MIMO radio panel according to some embodiments. Radio panel 202 may include a digital-to-analog convertor (DAC) 202, a power amplifier 206, an analog-to-digital convertor (ADC) 208, an ADC common calibration receiver 210, antenna panel coupling point 212 and common calibration receiver port 214. To simply the description, the following is made with reference to a transmission path, but it should be understood that the description may be applied to a receive path as well.

Each transmitter path of radio panel 302 has a DAC 204 and an ADC 208 pair. For gain control, each path must be calibrated such that the feedback power measured at ADC 208 is referenced to the power at an antenna feed which is antenna panel coupling point 212. It should be understood that radio panel 202 may include multiple DAC 204 and ADC 208 pairs.

The radio panel 202 in FIG. 2 is shown with four DAC/ADC pairs (DAC0/ADC0 to DACn/ADCn), four power amplifiers 206, and four radio panel coupling points 212. The MIMO antenna panel 202 may correspond with a 4×4 MIMO antenna panel. Similar to the above description with reference FIG. 1, the described configuration in FIG. 2 may be applied to a 2×2, 3×3, 8×8 etc. MIMO radio panel.

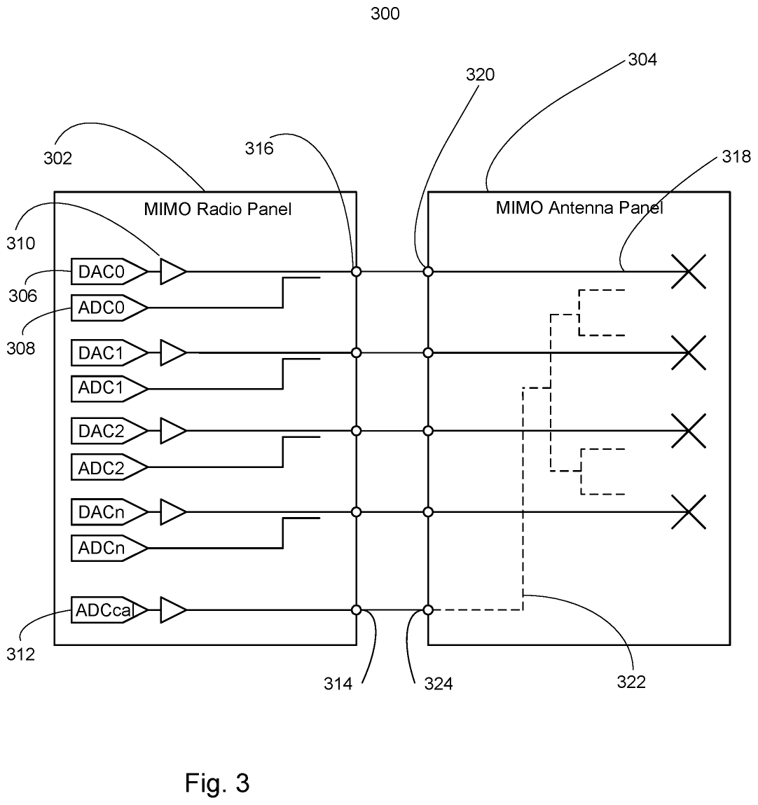

FIG. 3 illustrates a MIMO radio panel and a MIMO antenna panel assembly that in addition to normal transmit (or receive) operation is configured as a MIMO calibrating apparatus 300. The MIMO calibrating apparatus 300 includes a MIMO radio panel 302 and a MIMO antenna panel 304. The MIMO radio panel 302 includes a digital-to-analog convertor (DAC) 306, a power amplifier 310, an analog-to-digital convertor (ADC) 308, an ADC common calibration receiver 312, an ADC common calibration receiver port 314, and an antenna panel coupling point 316. The antenna panel coupling point 316 may also be referred to as an antenna feed.

The antenna panel 304 includes antenna and transmission line 318, antenna coupling point 320, calibration feedback network 322, and calibration feedback network coupling point 324 which is the input to the ADC common calibration receiver 312, via the ADC common calibration receiver port 314.

As stated with respect to FIG. 2, for simplicity the description of the a MIMO calibrating apparatus 300 is made with reference to a transmission path, but it should be understood that the description may also be applied to a receive path.

Each transmitter path has a DAC 306 and an ADC 308 pair. For gain control, each path must be calibrated such that the feedback power measured at the ADC 308 is referenced to the power at the corresponding radio antenna coupling point 314.

Also similar to the descriptions with reference to FIGS. 1 and 2, it should be understood that there may be multiple DAC 306/ADC 308 pairs (DAC0/ADC0-DACn/ADCn) with corresponding power amplifier 310 and antenna panel coupling points 316. The number of DAC 306/ADC 308 pairs with corresponding power amplifier 310 and antenna panel coupling points 316 may correspond with a equal number of radio panel coupling points 320 and corresponding antenna and transmission line 318.

FIG. 3 illustrates an example with four transmit paths coupled to four antenna transmit paths. That is, four antenna coupling points 316 of the radio panel 302 will couple one-to-one with four radio panel coupling points 320 of antenna panel 304. This may be a 4×4 MIMO configuration. The description, however, may be applied to a 2×2 MIMO configuration (where two antenna coupling points 316 of the radio panel 302 will couple one-to-one with two radio panel coupling points 320 of antenna panel 304), a 3×3 MIMO configuration (where three antenna coupling points 316 of the radio panel 302 will couple one-to-one with three radio panel coupling points 320 of antenna panel 304), an 8×8 MIMO configuration (where eight antenna coupling points 316 of the radio panel 302 will couple one-to-one with eight radio panel coupling points 320 of antenna panel 304), and so on.

The calibration feedback network 322 connects a coupled portion of each transmit path (antenna and transmission line 318) to common calibration receiver port 314 via calibration feedback network coupling point 324.

Once one path is set at a known power level the common calibration receiver port 314 may be referenced through the calibration feedback network 322. The relative loss of each path from the MIMO antenna panel 304 to the input for the common calibration receiver port 314 is known via the calibration feedback network 322 of the MIMO antenna panel 304. Measuring the loss at each antenna coupling point 320 which may be referred to as an input path (output path with reference to a receive path) may now be a single power measurement made before coupling the antenna panel 304 with the radio panel 302. Thus, the need for a switch box may be eliminated.

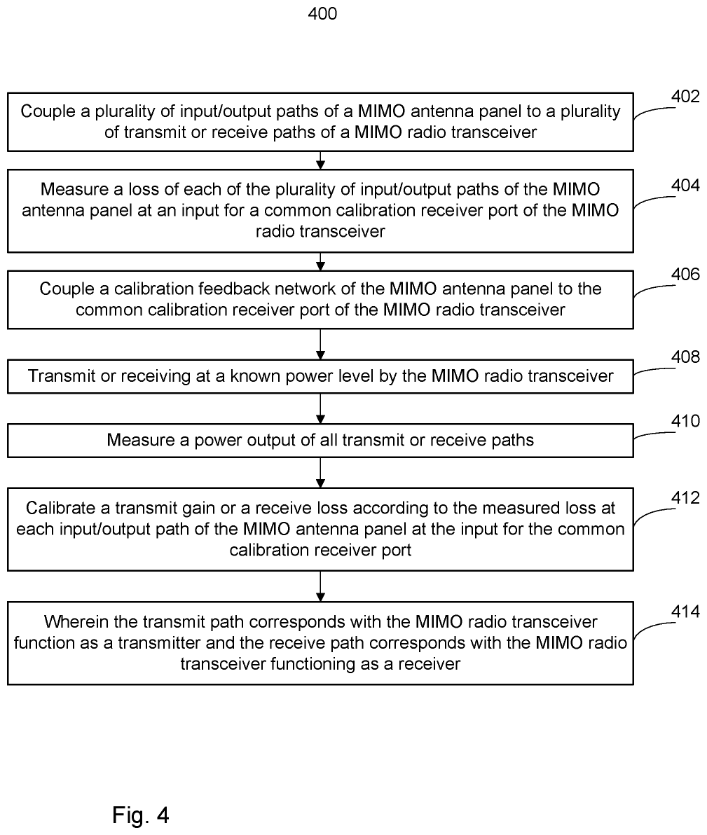

FIG. 4 is a flowchart of an example process 400. In some implementations, one or more process blocks of FIG. 4 may be performed by one or more devices.

As shown in FIG. 4, process 400 may include coupling a plurality of input/output paths of a MIMO antenna panel to a plurality of transmit or receive paths of a MIMO radio panel 402. For example, a MIMO calibrating apparatus may couple a plurality of input/output paths of a MIMO antenna panel to a plurality of transmit or receive paths of a MIMO radio panel, as described above. As also shown in FIG. 4, process 400 may include measuring a loss of each of the plurality of input/output paths of the MIMO antenna panel at an input for a common calibration receiver port of the MIMO radio panel at 404. For example, a MIMO calibrating apparatus may measure a loss of each of the plurality of input/output paths of the MIMO antenna panel at an input for a common calibration receiver port of the MIMO radio panel, as described above. As further shown in FIG. 4, process 400 may include coupling a calibration feedback network of the MIMO antenna panel to the common calibration receiver port of the MIMO radio panel at 406. For example, a MIMO calibrating apparatus may couple a calibration feedback network of the MIMO panel to the common calibration receiver port of the MIMO radio panel, as described above. As also shown in FIG. 4, process 400 may include transmitting or receiving at a known power level by the MIMO radio panel at 408. For example, an apparatus may transmit or receive at a known power level by the MIMO radio panel, as described above. As further shown in FIG. 4, process 400 may include measuring a power output of all transmit or receive paths at 410. For example, a MIMO calibrating apparatus may measure a power output of all transmit or receive paths, as described above. As also shown in FIG. 4, process 400 may include calibrating a transmit gain or a receive loss according to the measured loss at each input/output path of the MIMO antenna panel at the input for the common calibration receiver port at 412. For example, a MIMO calibrating apparatus may calibrate a transmit gain or a receive loss according to the measured loss at each input/output path of the MIMO antenna panel at the input for the common calibration receiver port, as described above.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

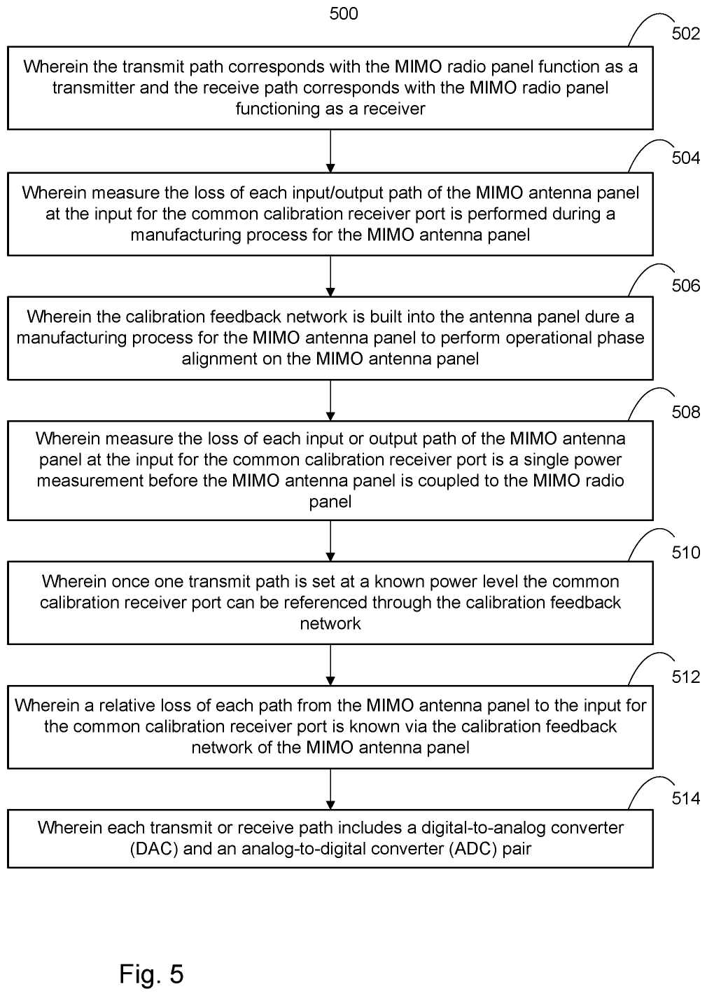

FIG. 5 is a flowchart of an example process 500. In some implementations, one or more process blocks of FIG. 5 may be performed by a MIMO calibrating apparatus.

Process 500 may include additional implementations, such as any single implementation or any combination of implementations described below and/or in connection with one or more other processes described elsewhere herein. In a first implementation, the transmit path corresponds with the MIMO radio panel functioning as a transmitter and the receive path corresponds with the MIMO radio panel functioning as a receiver 502.

In a second implementation, alone or in combination with the first implementation, measuring the loss of each input/output path of the MIMO antenna panel at the input for the common calibration receiver port is performed during a manufacturing process for the MIMO antenna panel 504.

In a third implementation, alone or in combination with the first and second implementation, the calibration feedback network is built into the antenna panel during a manufacturing process for the MIMO antenna panel to perform operational phase alignment on the MIMO antenna panel 506.

In a fourth implementation, alone or in combination with one or more of the first through third implementations, measuring the loss of each input or output path of the MIMO antenna panel at the input for the common calibration receiver port is a single power measurement before the MIMO antenna panel is coupled to the MIMO radio panel 508.

In a fifth implementation, alone or in combination with one or more of the first through fourth implementations, once one transmit path is set at a known power level the common calibration receiver port can be referenced through the calibration feedback network 510.

In a sixth implementation, alone or in combination with one or more of the first through fifth implementations, a relative loss of each path from the MIMO antenna panel to the input for the common calibration receiver port is known via the calibration feedback network of the MIMO antenna panel 512.

In a seventh implementation, alone or in combination with one or more of the first through sixth implementations, each transmit or receive path includes a digital-to-analog converter (DAC) and an analog-to-digital converter (ADC) pair 514.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

While aspects of the disclosure have been illustrated and described in detail in the drawings and foregoing description, such illustrations and description are to be considered illustrative or exemplary and not restrictive; the disclosure is not limited to the disclosed embodiments.

Other variations to the disclosed embodiments can be understood and effected by those skilled in the art in practicing the claimed features, from a study of the drawings, the disclosure, and the appended claims.

In the claims, the word “comprising” does not exclude other elements or steps, and the indefinite article “a” or “an” does not exclude a plurality.

A single processor, device or other unit may fulfill the functions of several items recited in the claims. The mere fact that certain measures are recited in mutually different dependent claims does not indicate that a combination of these measures cannot be used to advantage.

Operations like acquiring, accessing, determining, obtaining, outputting, providing, store or storing, calculating, simulating, receiving, warning, and stopping can be implemented as program code means of a computer program and/or as dedicated hardware.

A computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A method of calibrating Multiple-Input-Multiple-Output (MIMO) transceiver paths in a test environment, the method comprising:
coupling a plurality of input/output paths of a MIMO antenna panel to a plurality of transmit or receive paths of a MIMO radio panel;
measuring a loss of each of the plurality of input/output paths of the MIMO antenna panel at an input for a common calibration receiver port of the MIMO radio panel;
coupling a calibration feedback network of the MIMO antenna panel to the common calibration receiver port of the MIMO radio panel;
transmitting or receiving at a known power level by the MIMO radio panel;
measuring a power output of all transmit or receive paths; and
calibrating a transmit gain or a receive loss according to the measured loss at each input/output path of the MIMO antenna panel at the input for the common calibration receiver port.

2. The method of claim 1, wherein the transmit path corresponds with the MIMO radio panel functioning as a transmitter and the receive path corresponds with the MIMO radio panel functioning as a receiver.

3. The method according to claim 1, wherein measuring the loss of each input/output path of the MIMO antenna panel at the input for the common calibration receiver port is performed during a manufacturing process for the MIMO antenna panel.

4. The method according to claim 1, wherein the calibration feedback network is built into the antenna panel during a manufacturing process for the MIMO antenna panel to perform operational phase alignment on the MIMO antenna panel.

5. The method according to claim 1, wherein measuring the loss of each input or output path of the MIMO antenna panel at the input for the common calibration receiver port is a single power measurement before the MIMO antenna panel is coupled to the MIMO radio panel.

6. The method according to claim 1, wherein once one transmit path is set at a known power level the common calibration receiver port can be referenced through the calibration feedback network.

7. The method according to claim 6, wherein a relative loss of each path from the MIMO antenna panel to the input for the common calibration receiver port is known via the calibration feedback network of the MIMO antenna panel.

8. The method according to claim 1, wherein each transmit or receive path includes a digital-to-analog converter (DAC) and an analog-to-digital converter (ADC) pair.

9. A Multiple-Input-Multiple-Output (MIMO) calibrating apparatus comprising:
a MIMO antenna panel; and
a MIMO radio panel, wherein each of a plurality input/output paths of the MIMO antenna panel is coupled to each of a plurality of transmit or receive paths of the MIMO radio panel;
the MIMO antenna panel including:
a calibration feedback network; and
measurement data, the measurement data corresponding to a measured loss of each input or output path of the MIMO antenna panel to an input for a common calibration receiver port of the MIMO radio panel, wherein the calibration feedback network of the MIMO antenna panel is coupled to the common calibration receiver port of the MIMO radio panel;
the MIMO radio panel configured to:
transmit or receive data at a known power level;
measure a power output of all transmit or receive paths; and
calibrate a transmit gain or a receive loss according to the measurement data which is received at the common calibration receiver port of the MIMO radio panel.

10. The MIMO calibrating apparatus according to claim 9, wherein the transmit path corresponds with the MIMO radio panel functioning as a transmitter and the receive path corresponds with the MIMO radio panel functioning as a receiver.

11. The MIMO calibrating apparatus according to claim 9, wherein the measurement data corresponding to a measured loss of each input or output path of the MIMO antenna panel is generated during a manufacturing process for the MIMO antenna panel.

12. The MIMO calibrating apparatus according to claim 9, wherein the measurement data is derived from a single power measurement before the MIMO antenna panel is coupled to the MIMO radio panel.

13. The MIMO calibrating apparatus according to claim 9, wherein the common calibration feedback network is built into the antenna panel during a manufacturing process for the MIMO antenna panel to perform operational phase alignment on the MIMO antenna panel.

14. The MIMO calibrating apparatus according to claim 9, wherein once one transmit path is set at a known power level the calibration receiver port can be referenced through the calibration feedback network.

15. The MIMO calibrating apparatus according to claim 14, wherein a relative loss of each path from the MIMO antenna panel at the input for the common calibration receiver port is known via the calibration feedback network of the MIMO antenna panel.

16. The MIMO calibrating apparatus according to claim 9, wherein each transmit or receive path includes a digital-to-analog converter (DAC) and an analog-to-digital converter (ADC) pair.
